(19) United States
(12) Patent Application Publication
(10) Pub. No.: US 2023/0217928 A1
(43) Pub. Date: Jul. 13, 2023

(54) HERBICIDAL COMBINATION AND METHOD OF CONTROLLING HERBICIDE RESISTANT WEEDS

(71) Applicants: UPL Corporation Limited, Port Louis (MU); UPL Europe LTD, Warrington (GB)

(72) Inventor: Ferdinando Marcos Lima Silva, Port Louis (MU)

(21) Appl. No.: 17/925,202

(22) PCT Filed: May 12, 2021
(86) PCT No.: PCT/IB2021/054051

§ 371 Date: Nov. 14, 2022

(30) Foreign Application Priority Data
May 15, 2020 (IN) 202011020608

(51) Int. Cl. A01N 57/20; A01N 35/10

(52) U.S. Cl. CPC A01N 57/20; A01N 35/10

(57) ABSTRACT

The present invention relates to a method for the effective control of undesired weeds. Particularly, the present invention relates to a method of controlling undesired weeds that are resistant to herbicides.

### FIELD OF INVENTION

The present invention relates to the field of plant protection, particularly, to a method for the effective control of undesired weeds. More particularly, the present invention relates to a method of selectively controlling undesirable vegetation that are resistant to herbicides.

### BACKGROUND OF THE INVENTION

Weeds are undesirable plants that can severely damage yield in crops. Farmers usually control these plants at the pre-plant stage as well as after sowing. Modern herbicides are used to either control or suppress these undesirable plants to allow sown crops a greater share of nutrients.

Protection of planted crops from undesirable plants which inhibit crop growth is a perpetual struggle for all farmers. Herbicides have been used to control growth of such plants. There are many herbicides and combinations known in the art.

Current practices include combining herbicides with varied modes of action, which allows broader spectrum of control and resistance management. However, the combinations currently known are not sufficient to control the resistant and persistent weeds. There is always a need in the art for improved herbicidal combinations with enhanced weed control efficacy.

However, the combination of herbicides may not always result in the desired effect. Combination of herbicides may lead to an additive effect or an antagonistic effect. It may also result in phytotoxicity to the crops making it an undesirable combination. Agronomists must therefore, carefully select the herbicides that can be combined to offer a synergistic effect that would control weeds, while having no phytotoxic effect on the crop and reduce the chances of development of herbicide resistant weeds. Herbicide tank-mixtures may be used to prevent the development of herbicide-resistant weeds by attacking weeds at more than one lethal site of action. However, tank-mixtures may also result in unexpected interactions between herbicides, such as antagonism.

Glufosinate, a glutamine synthetase inhibitor herbicide or a Group H inhibitor herbicide is a broad-spectrum post emergent herbicide that controls most annual grasses and broadleaves. It is a contact herbicide with limited translocation throughout the plant. The glutamine synthetase herbicides inhibit activity of glutamine synthetase, the enzyme that converts glutamate and ammonia to glutamine. Glufosinate is an excellent tool for resistance management. It is mainly used for post-emergent control of weeds and grass weeds.

Glycines (glyphosate) are herbicides that inhibit 5-enolpyruvylshikimate-3-phosphate (EPSP) synthase, a key enzyme in the shikimic acid pathway, which is involved in the synthesis of the aromatic amino acids. Glyphosate [N-(phosphonomethyl)glycine] is a non-selective, broad spectrum, systemic, post-emergence herbicide that has been used extensively throughout the world over the past three decades for weed management. It inhibits the biosynthesis of aromatic amino acids (phenylalanine, tryptophan, and tyrosine), which leads to several metabolic disturbances, including the inhibition of protein and secondary product biosynthesis and the deregulation of the shikimate pathway, leading to general metabolic disruption.

Intensive glyphosate selection has resulted in the widespread evolution of glyphosate-resistant (GR) weed populations, threatening the sustainability of this valuable once-in-a-century agrochemical. Management of GR weeds is a challenge and the widespread occurrence of GR weeds in several states requires alternate weed management programs.

The ACCase Inhibitors are primarily used for postemergence grass control in broadleaf crops. These herbicides inhibit the enzyme acetyl-CoA carboxylase (ACCase), which catalyzes the first step in fatty acid synthesis and is important for membrane synthesis. Resistance to acetyl-CoA carboxylase herbicides is known in at least 43 grass weeds. When weeds evolve resistance to ACCase inhibitors, their management becomes more challenging due to the lack of alternative MoAs (mechanism of action) available for selective grass control in post-emergence. In addition, when resistance mechanisms involve herbicide metabolism, they can confer resistance to multiple herbicide mode of action.

Various weed species have now evolved resistance to many herbicides. Goosegrass, an annual grass, it is considered one of the ten “most important herbicide-resistant species” and its populations have evolved resistance to many herbicides, including PSI Electron Diverter (D/22), ACCase inhibitors (A/1), EPSP synthase inhibitors (G/9), Glutamine synthase inhibitors (H/10), Microtubule inhibitors (K1/3), PPO inhibitors (E/14), Multiple Resistance: 2 Sites of Action-PSI Electron Diverter (D/22), Glutamine synthase inhibitors (H/10) and like that (http://weedscience.org).

Eleusine indica (Goosegrass) represents one of the most common and problematic weeds worldwide. Goosegrass is a monocot weed in the Poaceae family.

Glyphosate-resistant (GR) Goosegrass is recently identified in Brazil. These particular biotypes are known to have resistance to fenoxaprop-P-ethyl, glyphosate, and haloxyfop-methyl and they may be cross-resistant to other herbicides in the Groups A/1, and G/9. This GR weed species need to be controlled by more than one herbicide in the program, which can be difficult and challenging with a very limited range of effective herbicide options.

Digitaria insularis commonly known as sourgrass is one of the most problematic weeds in South America because glyphosate resistance and is widespread across most crop production regions.

Herbicides have become increasingly important in agriculture and this reliance has resulted in an increase in the number of herbicide-resistant weed populations.

Interactions between glyphosate and glufosinate have been previously reported (Chuah et al. 2008; Kudsk and Mathiassen 2004). Antagonism was observed between these two herbicides in Goosegrass at all rates studied (Chuah et al. 2008). The antagonism was attributed to the fast action of glufosinate, which caused plant injury before the slower systemic glyphosate acted. A holistic strategy towards managing herbicide-resistant weeds is crucial for agricultural sustainability and rising crop yield rates that will provide food, fibers, and energy to a growing population. Integrated weed management is the combination of multiple weed control methods in order to reduce weed interference below the economic threshold level. Therefore, when weeds evolve resistance to herbicides, their management becomes more challenging due to the lack of alternative modes of action available for selective grass control in post-emergence.

Therefore, there remains an urgent need for improved practices for preventing, delaying or effectively managing the growth of weeds that develop herbicidal resistance, thereby improving the overall yield and plant health, with reduced phytotoxicity. Thus, there is also a need to develop herbicide combination strategies that are synergistic and helps in herbicide resistance management.

Embodiments of the present invention may therefore ameliorate one or more of the above-mentioned problems:

### OBJECTS OF THE INVENTION

It is an object of the present invention to provide a method for the effective control of herbicide-resistant weeds.

It is another object of the present invention to provide a method of controlling herbicide resistant weeds wherein said method comprises applying concurrently or subsequently or sequentially a herbicide combination to target weeds.

It is yet another object of the present invention to improve the method of controlling growth of herbicide resistant weeds and to solve associated problems such as poor control efficiency of the herbicides and phytotoxicity.

It is a further object of the present invention to provide a method for control of herbicide resistant weeds, wherein such method does not adversely affect the normal growth of useful plants, particularly crop plants growing in the vicinity or environment of weeds.

It is an advantageous object of the present invention to provide an efficient prevention and treatment method for the control of herbicide resistant weeds, said method being better than conventional methods.

The aforementioned objects and associated objects of the present invention would be apparent from the description of the invention as set out hereinafter.

### SUMMARY OF THE INVENTION

In one aspect the present invention relates to the field of plant protection, particularly, to a method for the effective control of undesired weeds.

In another aspect the present invention provides herbicidal compositions, which show enhanced herbicide action against undesirable harmful plants and/or have improved compatibility with plants, in particular crop plants.

Another aspect of the present invention is to provide a method for effective control of herbicide-resistant weeds, in particular the weeds that are resistant to 5-enolpyruvylshikimate-3-phosphate (EPSP) synthase inhibiting herbicide, glutamine synthetase inhibiting herbicide and acetyl-CoA carboxylase (ACCase) inhibiting herbicide in agriculture field.

In another aspect the present invention provides a method for controlling the growth of herbicide resistant weeds, which comprises contacting such weeds, or parts of it or its immediate environment, with the requisite herbicide combination as provided herein below.

Accordingly, in an aspect the present invention provides a method of controlling herbicide resistant weeds by applying concurrently or subsequently or sequentially to a locus a combination of herbicides, the said method comprising;
(i) a first application comprising one or more herbicides selected from 5-enolpyruvylshikimate-3-phosphate (EPSP) synthase inhibiting herbicides and/or glutamine synthetase inhibiting herbicides as the first application,
(ii) a second application comprising one or more herbicides selected from 5-enolpyruvylshikimate-3-phosphate (EPSP) synthase inhibiting herbicide, glutamine synthetase inhibiting herbicide and acetyl-CoA carboxylase (ACCase) inhibiting herbicide;

wherein the second application is applied at least 7 days after the first application.

In another aspect, the present invention provides a method of controlling weeds resistant to herbicides wherein said weeds are treated by applying concurrently or subsequently or sequentially a combination comprising herbicide to target weeds.

In another aspect the present invention provides a method for inhibiting, controlling, preventing, delaying and reducing, the rate of population of Poaceae weeds, in particular Eleusine indica and Digitaria insularis by applying concurrently or subsequently or sequentially a herbicide combination to target said weeds.

In another aspect, the present invention provides an effective and quick method for controlling herbicide resistant weeds, particularly Eleusine indica and Digitaria insularis.

In another aspect, the present invention provides a method of controlling Eleusine indica weeds wherein said method comprises applying concurrently or subsequently or sequentially a herbicide combination to target weeds.

In another aspect the present invention improves the control method and solves the problems such as the control efficiency being poor and efficient prevention and treatment purpose, better than conventional methods.

In another aspect the present invention provides a method which does not adversely affect the normal growth of plants.

In one aspect, the present invention provides a method for controlling herbicide resistant weeds, the said method may be applied either pre or post emergent.

Yet another aspect of the present invention is to provide a method of increasing yield in a crop by application of the present method using the said herbicidal combination.

Another aspect of the present invention is to provide a method of improving the crop health by application of the herbicidal combination.

In another aspect the present invention provides a complete strategy towards managing herbicide-resistant weeds for agricultural sustainability and rising crop yield rates.

### DETAILED DESCRIPTION OF THE INVENTION

For the purposes of the following detailed description, it is to be understood that the invention may assume various alternative variations, except where expressly specified to the contrary. Moreover, other than in any operating examples, or where otherwise indicated, all numbers expressing, for example, quantities of materials/ingredients used in the specification are to be understood as being modified in all instances by the term “about”. The term “about” used to qualify the amounts of active components shall be interpreted to mean “approximately” or “reasonably close to” and any statistically insignificant variations therefrom.

As used herein, the terms “comprising” “including,” “having,” “containing,” “involving,” and the like are to be understood to be open-ended, i.e., to mean including but not limited to.

In any aspect or embodiment described hereinbelow, the phrase comprising may be replaced by the phrases “consisting of” or “consisting essentially of”. In these aspects or embodiment, the combination or composition described includes or comprises or consists of or consists essentially of or consists substantially of the specific components recited therein, to the exclusion of other ingredients or excipients not specifically recited therein.

The term herbicide, as used herein, shall mean an active ingredient that kills, controls or otherwise adversely modifies the growth of undesired plants.

As used herein, a herbicidally effective or vegetation controlling amount is an amount of active ingredient that causes a “herbicidal effect,” i.e., an adversely modifying effect and includes deviations from natural development, killing, regulation, desiccation, retardation stunting, dwarfing and the like.

The terms “plants” and “vegetation” include, but are not limited to, germinant seeds, emerging seedlings, plants emerging from vegetative propagules, and established vegetation.

The terms “undesirable vegetation”, “harmful plants”, “unwanted plants”, “weeds” and “weed species”, as used herein, are synonyms.

The term “locus” as used herein shall denote the vicinity of a desired crop in which weed control, typically selective weed control is desired. The locus includes the vicinity of desired crop plants wherein the weed infestation has either emerged or is yet to emerge.

The term “crop” shall include a multitude of desired crop plants or an individual crop plant growing at a locus.

Each of the aspects described above may have one or more embodiments.

Each of the embodiments described hereinafter may apply to one or all of the aspects described hereinabove. These embodiments are intended to be read as being preferred features of one or all of the aspects described hereinabove. Each of the embodiments described hereinafter applies to each of the aspects described hereinabove individually.

Glyphosate-resistant (GR) Goosegrass was recently identified weed in Brazil. It is observed that the farmers have no option to control this weed, as it is resistant to systemic herbicides such as glyphosate or ACCase herbicides and other contact herbicides. Sourgrass is also one of the most problematic weeds because of its glyphosate resistance According to the present invention there is provided an effective and quick method to control this weed. The method comprises applying a herbicide combination as a sequential application which efficiently controls this weed.

Surprisingly, it has been found by the present inventors that a combination of a Group G inhibitors (5-enolpyruvylshikimate-3-phosphate (EPSP)), i.e. glyphosate with another herbicide selected from Group A inhibitors (acetyl-CoA carboxylase (ACCase) inhibiting herbicide), and Group H (glutamine synthetase inhibiting herbicides) inhibitors results in the effective control of herbicide resistant weeds at the locus of the desirable crop plants when applied in a sequential manner. The resulting phytotoxicity usually seen with application of glyphosate and glufosinate or combinations thereof for controlling weed is also absent when these herbicides were applied in a sequential manner as is described in the present invention.

In an embodiment, the present invention provides preferred combinations, compositions and methods thereof. The methods of the invention include a method of controlling weeds at a locus by applying to the locus the combination or the composition, or a method of increasing yield in a crop by application of the combination or composition, or a method of improving the plant health by application at the locus of the plant the combination or the composition. The embodiments described herein describe the preferred embodiments of all these possible combinations, compositions and methods of the invention.

Therefore, in an aspect the present invention provides a method of controlling herbicide resistant weeds by applying concurrently or subsequently or sequentially a combination of herbicides to a locus, the said method comprising,
(i) a first application comprising one or more herbicides selected from 5-enolpyruvylshikimate-3-phosphate (EPSP) synthase inhibiting herbicides and/or glutamine synthetase inhibiting herbicides, and
(ii) a second application comprising one or more herbicides selected from 5-enolpyruvylshikimate-3-phosphate (EPSP) synthase inhibiting herbicide, glutamine synthetase inhibiting herbicide and acetyl-CoA carboxylase (ACCase) inhibiting herbicide.

Thus in an aspect the present invention provides a herbicidal composition comprising one or more herbicides selected from 5-enolpyruvylshikimate-3-phosphate (EPSP) synthase inhibiting herbicides and/or glutamine synthetase inhibiting herbicides, and one or more herbicides selected from 5-enolpyruvylshikimate-3-phosphate (EPSP) synthase inhibiting herbicide, glutamine synthetase inhibiting herbicide and acetyl-CoA carboxylase (ACCase) inhibiting herbicide. The invention also relates to methods and uses for controlling undesirable vegetation, in particular in crops.

In another aspect the present invention provides a method for the effective control of herbicide-resistant weeds, wherein the herbicide resistant weeds are resistant to at least one herbicide belonging to Group A (ACCase-inhibiting herbicides), Group G (5-enolpyruvylshikimate-3-phosphate (EPSP) inhibiting herbicides) and Group H (glutamine synthetase inhibiting herbicides) inhibitors.

Typically, the target weeds of the present invention are resistant to glyphosate, ACCase herbicides, glufosinate and the like.

The present invention provides a method for controlling herbicide resistant weeds, in particular Poaceae weeds.

In a preferred embodiment the herbicide resistant weed is Eleusine indica (Goosegrass).

In one preferred embodiment the herbicide resistant weed is Digitaria insularis (sourgrass).

In another aspect the present invention provides a highly effective and a quick method for controlling Eleusine indica and Digitaria insularis that is resistant to herbicides under Group A, Group G and Group H.

In an embodiment the Group A or ACCase-inhibiting herbicide is selected from aryloxyphenoxypropionates (FOPs), cyclohexanodiones (DIMs), and phenylpyrazole (DENs).

In an embodiment, aryloxyphenoxy propionate is selected from clodinafop, cyhalofop, haloxyfop, fenoxaprop, fluazifop and quizalofop.

In an embodiment, cyclohexanedione is selected from clethodim and sethoxydim.

In an embodiment, phenylpyrazolin is pinoxaden.

In an embodiment the Group G or 5-enolpyruvylshikimate-3-phosphate EPSP Synthase Inhibitor is selected from the organophosphorous chemical family.

In an embodiment the EPSP Synthase Inhibitor is glyphosate.

In an embodiment the Group H or Glutamine Synthetase Inhibitor is selected from the organophosphorous chemical family.

In an embodiment the Glutamine Synthetase Inhibitor is glufosinate.

Preferably, the composition according to the invention comprises glufosinate in free form or in salt form, in particular potassium, sodium, ammonium, trimethylsulfonium, monoethanolammonium, isopropylammonium, triazolamine salt. Preferably glufosinate ammonium is used as selective herbicide.

In another aspect, the present invention provides a method of controlling weeds resistant to herbicides wherein said weeds are treated by applying concurrently or sequentially, herbicidally effective amounts of at least two herbicides to target weeds.

In another aspect, the present invention provides a method of controlling weeds resistant to herbicides, wherein said weeds are treated by applying concurrently or sequentially at a locus of a crop plant, a composition comprising herbicidally effective amount of combination of herbicides.

Preferably, the method comprises applying glyphosate with a sequential application of glufosinate to effectively control herbicide resistant weed, which is Eleusine indica.

In an embodiment the method of present invention significantly controls the herbicide resistant weeds within a period of 10 to 30 days.

In an embodiment the method comprises applying a herbicidally effective amount of the combination of herbicides within a period of 10 to 30 days.

In an embodiment the method comprises applying a herbicidally effective amount of the combination of herbicides concurrently or sequentially within a period of 10 to 30 days, preferably within a period of 10 to 15 days.

According to the method of the present invention, adult plants of Eleusine indica that is resistant to herbicide is best controlled with the application of glyphosate followed by application of another herbicide, glufosinate after a time interval of 10 to 30 days, preferably within a period of 10 to 15 days.

The combination may be applied to the locus of the weeds in an herbicidally effective amounts. The selection of the appropriate effective amounts depends on the density of weed infestation, weather patterns, crop health and many other factors.

In an embodiment, glufosinate or glyphosate or their salts may be used in an amount of from about 1 g/ha to about 5000 g/ha.

In an embodiment, glyphosate may be used in an amount from about 5 g/ha to about 500 g/ha.

In an embodiment, glyphosate may be used in an amount about 200 g/ha.

In an embodiment, glyphosate may be used in an amount about 400 g/ha.

In an embodiment, glufosinate may be used in an amount from about 5 g/ha to about 500 g/ha.

In an embodiment, glufosinate may be used in an amount about 100 g/ha.

In an embodiment, glufosinate may be used in an amount about 200 g/ha.

In an embodiment, the herbicides of the present invention may be applied with at least one other active ingredient selected from the group consisting of herbicides, insecticides, fungicides, biological agents, plant growth activators, fertilizers or combinations thereof.

The compositions may further comprise at least one agrochemically acceptable excipient.

The dosage level of the individual herbicides may be defined by the inherent efficacy of the compound, the pest pressure, soil type, the weather, the formulation type and many other indeterminate variables. These standard dosage levels are fixed by the regulatory authorities.

These compositions can be applied by spraying onto the weeds to be treated. The application dose will of course depend on the nature of the crop and the weed to be treated. For example, these herbicide combinations, compositions can be applied at a rate of 0.1 to 10 L/ha, preferably from 0.5 to 8 L/ha, and even more preferably from 1 to 5 L/ha, typically 3 L/ha of crop to be treated.

In an embodiment, the individual components of the combination of the present invention may be applied to the locus either simultaneously or sequentially, such that glyphosate and glufosinate may be applied in a tank mix or as a pre-mixed composition within a period of 10 to 30 days of each other.

The herbicidal compositions of the present disclosure can be in any conventional agriculturally useful form, for example, in the form of a ready-to-use formulation, or in the form of a tank mix.

In an embodiment, the herbicidal compositions of the present disclosure are tank mixes.

In an embodiment, combination of the present invention may be applied either pre or post emergent. The advantage of the combination is surprisingly good residual effects, when applied in post-emergent leading to quick control of weeds.

In an embodiment, the composition of the present invention may contain agriculturally acceptable adjuvants, carriers, diluents, emulsifiers, fillers, antifoaming agents, thickening agents, anti-freezing agents, freezing agents etc. The compositions may be either solid or liquids. They can be solids, such as, for example, dusts, granules, water-dispersible granules, microcapsules or wettable powders, or liquids, such as, for example, emulsifiable concentrates, solutions, emulsions or suspensions, ZC formulations. They can also be provided as a pre-mix or tank mixes.

Suitable agricultural adjuvants and carriers may include, but are not limited to, crop oil concentrates; methylated seed oils, emulsified methylated seed oil, nonylphenol ethoxylate; benzylcocoalkyldimethyl quaternary ammonium salt; blend of petroleum hydrocarbon, alkyl esters, organic acid, and anionic surfactant; C9-C11 alkylpolyglycoside; phosphated alcohol ethoxylate; natural primary alcohol (C12-C16) ethoxylate; di-sec-butylphenol EO-PO block copolymer; polysiloxane-methyl cap; nonylphenol ethoxylate, urea ammonium nitrate; tridecyl alcohol (synthetic) ethoxylate (8EO); tallow amine ethoxylate; PEG(400) dioleate-99, alkyl sulfates, such as diethanolammonium lauryl sulfate; alkylarylsulfonate salts, such as calcium dodecylbenzenesulfonate; alkylphenol-alkylene oxide addition products, such as nonylphenol-C18 ethoxylate; alcohol-alkylene oxide addition products, such as tridecyl alcohol-C16 ethoxylate; soaps, such as sodium stearate; alkyl-naphthalene-sulfonate salts, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, and in certain embodiments, methyl esters.

Suitable liquid carriers that may be employed in a composition of the present invention may include water or organic solvents. The organic solvents include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Organic solvents include, but are not limited to toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide.

Solid carriers that may be employed in the compositions of the present invention may include but are not limited to attapulgite, pyrophyllite clay, silica, kaolin clay, kieselguhr, chalk, diatomaceous earth, lime, calcium carbonate, bentonite clay, Fuller's earth, talc, cottonseed hulls, wheat flour, soybean flour, pumice, wood flour, walnut shell flour, lignin, cellulose etc.

Other exemplary additives which can be used in the compositions provided herein include, but not limited to, at least one compatibilizers, antifoaming agents, sequestering agents, neutralizing agents and buffers, corrosion inhibitors, coloring agents, odorants, spreading agents, permeation aids, fixing agents, dispersants, thickeners, freezing point depressants, anti-microbial agents etc.

In another aspect, method may further comprise applying at least one adjuvant or at least one safener.

In accordance with present invention the method of control of target weeds may be carried out by spraying the suggested tank mixes, or the individual herbicides may be formulated as a kit-of-parts containing various components that may be mixed as instructed prior to spraying.

The herbicidal combinations of the present invention maybe used to target weeds among the crops such as corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., vines, kaki fruit, olive, plum, banana, oil palm, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

The target weeds are selected from family of Poaceae weeds.

The Poaceae weeds are selected from a group comprising Echinochloa crus-galli, Setaria viridis, Setaria faberi, Setaria glauca, Setaria geniculata, Digitaria ciliaris, Digitaria sanguinalis, Digitaria horizontalis, Digitaria insularis, Eleusine indica, Poa annua, Alospecurus aequalis, Alopecurus myosuroides, Avena fatua, Sorghum halepense, Sorghum vulgare, Agropyron repens, Lolium multiflorum, Lolium perenne, Lolium rigidum, Bromus secalinus, Bromus tectorum, Hordeum jubatum, Aegilops cylindrica, Phalaris arundinacea, Phalaris minor, Apera spica-venti, Panicum dichotomiflorum, Panicum texanum, Panicum maximum, Brachiaria platyphylla, Brachiaria ruziziensis, Brachiaria plantaginea, Brachiaria decumbens, Brachiaria brizantha, Brachiaria humidicola, Cenchrus echinatus, Cenchrus pauciflorus, Eriochloa villosa, Pennisetum setosum, Chloris gayana, Eragrostis pilosa, Rhynchelitrum repens, Dactyloctenium aegyptium, Ischaemum rugosum, Oryza sativa, Paspalum notatum, Paspalum maritimum, Pennisetum clandestinum, Pennisetum setosum or Rottboellia cochinchinensis.

Preferably the target weed is Eleusine indica.

In each of these embodiments, apart from glyphosate, the embodiments may include applying the preferred glutamine synthetase herbicide.

The method of controlling Eleusine indica weeds according to the present invention wherein said method comprises applying concurrently or subsequently or sequentially herbicide combination to target weeds.

In an embodiment, the adult plants of Eleusine indica which is resistant to herbicides like glyphosate and ACCase inhibitors (fenoxaprop, haloxyfop and clethodim) can be effectively controlled by sequential application of glyphosate and 10 to 15 days later application of glufosinate to target herbicide resistant weeds.

Therefore, in an embodiment, the present invention provides a method of controlling weeds at a locus, the method comprising:
(a) applying glyphosate at the target locus; and
(b) within about 10 to about 15 days, applying glufosinate to the locus.

In another embodiment, the present invention provides a method of controlling weeds at a locus, the method comprising:
(a) applying glyphosate to the locus; and
(b) applying glufosinate to the locus, wherein glufosinate is applied at least 7 days after the application of glyphosate.

In another embodiment, the present invention provides a method of controlling weeds at a locus, the method comprising:
(a) applying glyphosate to the locus; and
(b) applying glufosinate to the locus, wherein glufosinate is applied at least 14 days after the application of glyphosate.

In another embodiment, the present invention provides a method of controlling weeds at a locus, the method comprising:
(a) applying glyphosate to the locus; and
(b) applying glufosinate to the locus, wherein glufosinate is applied at least 21 days after the application of glyphosate.

In another embodiment, the present invention provides a method of controlling weeds at a locus, the method comprising:
(a) applying glyphosate to the locus; and
(b) applying glufosinate to the locus, wherein glufosinate is applied at least 28 days after the application of glyphosate.

In another embodiment, the present invention provides a method of controlling weeds at a locus, the method comprising:
(a) applying glyphosate to the locus; and
(b) applying glufosinate to the locus, wherein glufosinate is applied at least 35 days after the application of glyphosate.

In another embodiment, the present invention provides a method of controlling weeds at a locus, the method comprising:
(a) applying glyphosate to the locus; and
(b) applying glufosinate to the locus, wherein glufosinate is applied at least 42 days after the application of glyphosate.

In another embodiment, the present invention provides a method of controlling weeds at a locus, the method comprising:
(a) applying glyphosate to the locus; and
(b) applying glufosinate to the locus, wherein glufosinate is applied at least 49 days after the application of glyphosate.

In another embodiment, the present invention provides a method of controlling weeds at a locus, the method comprising:
(a) applying glyphosate to the locus; and
(b) applying glufosinate to the locus, wherein glufosinate is applied at least 56 days after the application of glyphosate.

In another embodiment, the present invention provides a method of controlling weeds at a locus, the method comprising:
(a) applying a combination comprising glyphosate and glufosinate to the locus; and
(b) applying the combination comprising glyphosate and glufosinate to the locus, wherein the second application is applied at least 7 days after the first application.

In another embodiment, the present invention provides a method of controlling weeds at a locus, the method comprising:
(a) applying a combination comprising glyphosate and glufosinate to the locus; and
(b) applying the combination comprising glyphosate and glufosinate to the locus, wherein the second application is applied at least 14 days after the first application.

In another embodiment, the present invention provides a method of controlling weeds at a locus, the method comprising:
(a) applying a combination comprising glyphosate and glufosinate to the locus; and
(b) applying the combination comprising glyphosate and glufosinate to the locus, wherein the second application is applied at least 21 days after the first application.

In another embodiment, the present invention provides a method of controlling weeds at a locus, the method comprising:
(a) applying a combination comprising glyphosate and glufosinate to the locus; and
(b) applying the combination comprising glyphosate and glufosinate to the locus, wherein the second application is applied at least 28 days after the first application.

In another embodiment, the present invention provides a method of controlling weeds at a locus, the method comprising:
(a) applying a combination comprising glyphosate and glufosinate to the locus; and
(b) applying the combination comprising glyphosate and glufosinate to the locus, wherein the second application is applied at least 35 days after the first application.

In another embodiment, the present invention provides a method of controlling weeds at a locus, the method comprising:
(a) applying a combination comprising glyphosate and glufosinate to the locus; and
(b) applying the combination comprising glyphosate and glufosinate to the locus, wherein the second application is applied at least 42 days after the first application.

In another embodiment, the present invention provides a method of controlling weeds at a locus, the method comprising:
(a) applying a combination comprising glyphosate and glufosinate to the locus; and
(b) applying the combination comprising glyphosate and glufosinate to the locus, wherein the second application is applied at least 49 days after the first application.

In another embodiment, the present invention provides a method of controlling weeds at a locus, the method comprising:
(a) applying a combination comprising glyphosate and glufosinate to the locus; and
(b) applying the combination comprising glyphosate and glufosinate to the locus, wherein the second application is applied at least 56 days after the first application.

In an embodiment, the glyphosate herbicide is applied along with nicosulfuron at 750 g/kg.

In an embodiment, the glyphosate herbicide is applied along with nicosulfuron at 240 g/kg.

In another aspect the present invention provides a method of controlling herbicide resistant weeds such that, the method can be applied at pre or post emergence of weeds, thereby providing resistance management and complete control of the weeds.

The present invention thus provides a method for management of Eleusine indica resistant to glyphosate and ACCase inhibitors and other herbicides, said method comprising sequentially applying the combination of herbicides.

Preferably the target weed is Digitaria insnularis

In each of these embodiments, apart from glyphosate, the embodiments may include applying the preferred glutamine synthetase herbicide and ACCase inhibitors.

The method of controlling Digitaria insnularis weeds according to the present invention wherein said method comprises applying concurrently or subsequently or sequentially herbicide combination to target weeds.

In an embodiment, the adult plants of Digitaria insularis which is resistant to herbicides like glyphosate can be effectively controlled by sequential application of a glutamine synthase inhibitor and 7 to 60 days later application of a glutamine synthase inhibitor and/or ACCase inhibitors to target herbicide resistant weeds.

In an embodiment, the adult plants of Digitaria insularis which is resistant to herbicides like glyphosate can be effectively controlled by sequential application of a glufosinate and/or ACCase inhibitors and 7 to 60 days later application of a glufosinate and/or ACCase inhibitors to target herbicide resistant weeds.

In another embodiment, the present invention provides a method of controlling weeds at a locus, the method comprising:
(a) applying glufosinate and/or ACC'ase inhibitor herbicide to the locus; and
(b) applying glufosinate and/or ACC'ase inhibitor herbicide to the locus, wherein glufosinate is applied at least 7 days after the first application.

In another embodiment, the present invention provides a method of controlling weeds at a locus, the method comprising:
(a) applying glufosinate and/or ACC'ase inhibitor herbicide to the locus; and
(b) applying glufosinate and/or ACC'ase inhibitor herbicide to the locus, wherein glufosinate is applied at least 14 days after the first application.

In another embodiment, the present invention provides a method of controlling weeds at a locus, the method comprising:
(a) applying glufosinate and/or ACC'ase inhibitor herbicide to the locus; and
(b) applying glufosinate and/or ACC'ase inhibitor herbicide to the locus, wherein glufosinate is applied at least 21 days after the first application.

In another embodiment, the present invention provides a method of controlling weeds at a locus, the method comprising:
(a) applying glufosinate and/or ACC'ase inhibitor herbicide to the locus; and
(b) applying glufosinate and/or ACC'ase inhibitor herbicide to the locus, wherein glufosinate is applied at least 28 days after the first application.

In another embodiment, the present invention provides a method of controlling weeds at a locus, the method comprising:
(a) applying glufosinate and/or ACC'ase inhibitor herbicide to the locus; and
(b) applying glufosinate and/or ACC'ase inhibitor herbicide to the locus, wherein glufosinate is applied at least 35 days after the first application.

In another embodiment, the present invention provides a method of controlling weeds at a locus, the method comprising:
(a) applying glufosinate and/or ACC'ase inhibitor herbicide to the locus; and
(b) applying glufosinate and/or ACC'ase inhibitor herbicide to the locus, wherein glufosinate is applied at least 42 days after the first application.

In another embodiment, the present invention provides a method of controlling weeds at a locus, the method comprising:
(a) applying glufosinate and/or ACC'ase inhibitor herbicide to the locus; and
(b) applying glufosinate and/or ACC'ase inhibitor herbicide to the locus, wherein glufosinate is applied at least 58 days after the first application.

In another aspect the method of present invention provides effective controlling in herbicide resistant weeds such that, the method can be applied at pre or post emergence of weeds, thereby providing resistance management and complete control of the weeds.

In an aspect, the compositions of the present invention may be presented in the form of a multi-pack herbicidal product or as a kit-of-parts for treatment of targeted weeds.

In one aspect, the present invention provides a use of a method for controlling herbicide resistant weeds by applying concurrently or subsequently or sequentially to the locus of a herbicide resistant plant an effective amount of a combination of herbicides.

The present invention therefore provides a method of controlling weeds thereby providing resistance management and synergistic control of the weeds. The present invention also provides an adequate method to achieve complete control of weeds, improving yields, while targeting resistance management.

The invention will now be described in more details with reference to the following examples. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and following examples, but by all embodiments and methods within the scope and spirit of the invention.

### EXAMPLES

### Example 1

Trial data for evaluating management of Eleusine indica weed Trials were carried out for evaluating the effect of herbicidal combinations on target weeds of Eleusine indica. The application effect of the herbicides according to the invention on the growth of herbicide resistant undesirable plants was demonstrated by the following greenhouse experiments. The evaluation for the damage on undesired weeds caused by the present compositions was carried out using a scale from 0 to 100%, compared to the untreated control plants. Here, 0 means no damage and 100 means complete destruction of the plants. The percentage coverage of each weed at time t=0 and the time t=T was noted, and the percentage control was calculated from the observed percent weed coverage data. In the following experiments, the herbicidal activity for the individual herbicidal compositions (solo and combination applications) was assessed till 21 days after treatment.

In this trial, time T was application time, A—0 days, B—7 days, C— 14 days and D—21 days after application of the tested herbicides post emergence of weeds (spray volume 150 L/ha). Application “A” is the condition when the weed height is about 30-40 cm. The final values reported were the average of five (5) repetitions. The tested herbicides were sourced from the formulations readily available i.e. Glyphotal TR (glyphosate, 480 g a. i./L and Fascinate (glufosinate, 200 g a. i./L).

Thus, in an embodiment, the present invention also relates to a method of controlling weeds at a locus, said method comprising applying glyphosate to the locus, and applying glufosinate on the seventh day after applying glyphosate.

Thus, in an embodiment, the present invention also relates to a method of controlling weeds at a locus, said method comprising applying glyphosate 480 g/L formulation at a rate of 3.0 L/ha to the locus, and applying glufosinate 200 g/L formulation at a rate of 3.0 L/ha on the seventh day after applying glyphosate.

Thus, in an embodiment, the present invention also relates to a method of controlling weeds at a locus, said method comprising applying glyphosate to the locus, and applying glufosinate on the fourteenth day after applying glyphosate.

Thus, in an embodiment, the present invention also relates to a method of controlling weeds at a locus, said method comprising applying glyphosate 480 g/L formulation at a rate of 3.0 L/ha to the locus, and applying glufosinate 200 g/L formulation at a rate of 3.0 L/ha on the fourteenth day after applying glyphosate.

Thus, in an embodiment, the present invention also relates to a method of controlling weeds at a locus, said method comprising applying glyphosate to the locus, and applying glufosinate on the twenty-first day after applying glyphosate.

Thus, in an embodiment, the present invention also relates to a method of controlling weeds at a locus, said method comprising applying glyphosate 480 g/L formulation at a rate of 3.0 L/ha to the locus, and applying glufosinate 200 g/L formulation at a rate of 3.0 L/ha on the twenty-first day after applying glyphosate.

Thus, in an embodiment, the present invention also relates to a method of controlling weeds at a locus, said method comprising applying a combination of glyphosate and glufosinate to the locus, and applying a combination of glyphosate and glufosinate on the fourteenth day after the first application.

Thus, in an embodiment, the present invention also relates to a method of controlling weeds at a locus, said method comprising applying glyphosate 480 g/L formulation at a rate of 3.0 L/ha and glufosinate 200 g/L formulation at a rate of 3.0 L/ha to the locus, and applying glyphosate 480 g/L formulation at a rate of 3.0 L/ha and glufosinate 200 g/L formulation at a rate of 3.0 L/ha on the fourteenth day after the first application.

TABLE 1

| | Treatment Active | Dose | |
|---|---|---|---|
| | (concentration | (L or | Application |
| Treatment no. | g/L or Kg) | Kg/ha) | Time (T) |
| 1 | Untreated | — | — |
| 2 | glyphosate (480) | 3.0 | A |
| | glufosinate (200) | 3.0 | B- 7DAA “A” |
| 3 | glyphosate (480) | 3.0 | A |
| | glufosinate (200) | 3.0 | C- 14DAA “A” |
| 4 | glyphosate (480) | 3.0 | A |
| | glufosinate (200) | 3.0 | D- 21DAA “A” |
| 5 | glyphosate (480) | 3.0 | A |
| | glufosinate (200) | 3.0 | |
| 6 | glyphosate (480) | 3.0 | C-14DAA “A” |
| | glufosinate (200) | 3.0 | |
| 7 | glyphosate (480) | 3.0 | A |
| | glufosinate (200) | 3.0 | |
| | glyphosate (480) | 3.0 | C-14DAA “A” |
| | glufosinate (200) | 3.0 | |

The results were tabulated as hereunder:

TABLE 2

| Treatment No. | Treatment | | 7 DA “A” | 14 DA “A” | 21 DA “A” | 28 DA “A” |
|---|---|---|---|---|---|---|
| 1 | Control | — | 0 | 0 | 0 | 0 |
| 2 | Glyphosate | Glufosinate | 26.7 | 72.3 | 77.3 | 80.7 |
| | (A) | (B) | | | | |
| 3 | Glyphosate | Glufosinate | 26.7 | 58.3 | 83.3 | 84.3 |
| | (A) | (C) | | | | |
| 4 | Glyphosate | Glufosinate | 30 | 58.3 | 76.7 | 85 |
| | (A) | (D) | | | | |
| 5 | Glyphosate + | — | 78.3 | 91 | 94.3 | 95 |
| | Glufosinate | | | | | |
| | (A) | | | | | |
| 6 | Glyphosate + | — | 0 | 0 | 65 | 60 |
| | Glufosinate | | | | | |
| | (C) | | | | | |
| 7 | Glyphosate + | Glyphosate + | 78 | 90 | 95 | 100 |
| | Glufosinate | Glufosinate | | | | |
| | (A) | (C) | | | | |

| | | | | |
|---|---|---|---|---|
| CV % | 14.8 | 7.1 | 4.8 | 5.0 |

Means followed by the same letter do not differ significantly by the Tukey test (p<0.05). Coefficient of variation (CV) %=12.4

Comparing the period of application of glyphosate (first application) and sequential application of glufosinate (second application), the longest period between them i.e 21 DAA ‘A’ showed better weed control, followed by the immediate period i.e. 14 DAA of ‘A’ and finally the shortest period i.e. 7 DAA of ‘A’.

It was observed that a single application of tank mixture of glyphosate and glufosinate at the time of application ‘A’ and sequential application of the same at 14 DAA of ‘A’, showed better control and also showed no regrowth of Eleusine indica plants.

Therefore, it was concluded that the present method of controlling herbicide resistant weeds and the combinations as discussed in the aforementioned table unexpectedly causes synergistic control of Eleusine indica adult weeds.

### Example 2

Trial Data for Evaluating Management of Digitaria insularis Weed

Trials were carried out for evaluating the effect of herbicidal combinations on target weeds of Digitaria insularis. The application effect of the herbicides on the growth of herbicide resistant undesirable plants was demonstrated. The evaluation for the damage on undesired weeds at flowering stage caused by the present method was carried out using a scale from 0 to 100%, compared to the untreated control plants. Here, 0 means no damage and 100 means complete destruction of the plants.

The percentage coverage of each weed at time t=0 and the time t=T was noted, and the percentage control was calculated from the observed percent weed coverage data. In the following experiments, the herbicidal activity for the individual herbicidal compositions (solo and combination applications) was assessed till 21 days after treatment.

In this trial, time T was application time, wherein A1—0 days, i.e. at the time of the first application, the sequential second application of herbicides was done after a time interval of 58 days from A1, therefore A2 represents 58 days after the first application (A1), B—14 days after the second application (14 DAA2), C—21 days after the second application (21 DAA2), D—28 days after the second application (28DAA2) and E—42 days after the second application (42 DAA2). The application of the present combination of herbicides post emergence of weeds was done at a spray volume of 150 L/ha.

The final values reported were the average of four (4) repetitions. The tested herbicides were sourced from the formulations readily available i.e. Glyphotal TR (glyphosate, 480 g a. i./L Fascinate (glufosinate, 200 g a. i./L), and UPL 340 (cletodim & haloxyfop (250+200 g a. i./L)).

In an embodiment, the present invention provides a method of controlling Digitaria insularis at a locus, said method comprising applying glufosinate to the locus, and applying cletodim and haloxyfop on the 58^{th} day after applying glufosinate.

Thus, in an embodiment, the present invention provides a method of controlling controlling Digitaria insularis at a locus, said method comprising applying 200 g/L glufosinate formulation at a rate of 2.5 L/ha to the locus, and applying 250 g/L cletodim and 200 g/L haloxyfop formulation at a rate of 0.4 L/ha on the fifty eight day after applying glufosinate.

In an embodiment, the present invention provides a method of controlling Digitaria insularis at a locus, said method comprising applying a combination of glufosinate, cletodim and haloxyfop to the locus, and applying a combination of glufosinate, cletodim and haloxyfop to the locus on the 58^{th} day after the first application.

Thus, in an embodiment, the present invention provides a method of controlling controlling Digitaria insularis at a locus, said method comprising applying a combination of 200 g/L glufosinate formulation at a rate of 2.5 L/ha to the locus, and 250 g/L cletodim and 200 g/L haloxyfop formulation at a rate of 0.4 L/ha; applying a combination of 200 g/L glufosinate formulation at a rate of 2.5 L/ha to the locus, and 250 g/L cletodim and 200 g/L haloxyfop formulation at a rate of 0.4 L/ha on the fifty eight day after the first application.

TABLE 3

| | Treatment Active | Dose | |
|---|---|---|---|
| | (concentration | (L or | Application |
| Treatment no. | g/ha) | Kg/ha) | Time (T) |
| 1 | Untreated | — | — |
| 2 | Glyphosate (480) | 3.0 | A1 |
| | Glyphosate (480) | 3.0 | A2- 58 DAA1 |
| 3 | Glufosinate (200) | 2.5 | A1 |
| | Glufosinate (200) | 2.5 | A2- 58 DAA1 |
| 4 | Glufosinate (200) | 2.5 | A1 |
| | Cletodim + Haloxyfop | 0.4 | A2- 58 DAA1 |
| | (250 + 200) | | |
| 5 | Glufosinate (200) + | 2.5 + 0.4 | A1 |
| | Cletodim + Haloxyfop | | |
| | (250 + 200) | | |
| | Glufosinate (200) + | 2.5 + 0.4 | A2- 58 DAA1 |
| | Cletodim + Haloxyfop | | |
| | (250 + 200) | | |

TABLE 4 (i)
% D. insularis control after application 1

| Treatment No. | Treatment | | 7 DAA1 | 14 DAA1 | 21 DAA1 | 35DAA1 | 57DAA1 |
|---|---|---|---|---|---|---|---|
| 1 | Control | — | 0.0 | 0.0 | 0.0 | 0.0 | 0.0 |
| 2 | Glyphosate | Glyphosate | 17.5 | 40.0 | 55.0 | 58.8 | 43.8 |
| | (A1) | (A2) | | | | | |
| 3 | Glufosinate | Glufosinate | 40.8 | 52.0 | 66.3 | 67.5 | 52.5 |
| | (A1) | (A2) | | | | | |
| 4 | Glufosinate | Cletodim + | 39.0 | 50.5 | 65.0 | 66.3 | 45.0 |
| | (A1) | Haloxyfop | | | | | |
| | | (A2) | | | | | |
| 5 | Glufosinate + | Glufosinate + | 51.8 | 85.0 | 88.8 | 91.3 | 66.3 |
| | Cletodim + | Cletodim + | | | | | |
| | Haloxyfop | Haloxyfop | | | | | |
| | (A1) | (A2) | | | | | |

TABLE 4 (ii)
% D. insularis control after application 2 (58DAA1)

| Treatment No. | Treatment | | 14 DAA2 | 21 DAA2 | 28DAA2 | 42DAA2 |
|---|---|---|---|---|---|---|
| 1 | Control | — | 0.0 | 0.0 | 0.0 | 0.0 |
| 2 | Glyphosate | Glyphosate | 48.8 | 45.0 | 45.0 | 38.8 |
| | (A1) | (A2) | | | | |
| 3 | Glufosinate | Glufosinate | 48.8 | 48.8 | 45.0 | 38.8 |
| | (A1) | (A2) | | | | |
| 4 | Glufosinate | Cletodim + | 89.0 | 89.5 | 92.0 | 93.3 |
| | (A1) | Haloxyfop | | | | |
| | | (A2) | | | | |
| 5 | Glufosinate + | Glufosinate + | 94.3 | 92.8 | 91.0 | 92.3 |
| | Cletodim + | Cletodim + | | | | |
| | Haloxyfop | Haloxyfop | | | | |
| | (A1) | (A2) | | | | |

It was observed that comparing the control of weeds during the period of application of glufosinate (first application) and sequential application of cletodim and haloxyfop (second application at 58 DAA1), the duration of 14 days, 21 days, 28 days and 42 days after the second application showed exemplary control of weeds, with control % reaching up to 93% control.

It was observed that an application of tank mixture of glufosinate+cletodim and haloxyfop at the time of application ‘A1’ and sequential application of the said tank mixture at A2 (i.e. 58 DAA1), showed enhanced control of Digitaria insularis.

### Advantages of the Present Invention

The present invention provides a method for the effective control of herbicide-resistant weeds.

The present invention improves the method of controlling growth of herbicide resistant weeds and solves associated problems such as poor control efficiency of the herbicides and phytotoxicity.

The present invention to provide a method for control of herbicide resistant weeds, wherein such method does not adversely affect the normal growth of useful plants, particularly crop plants growing in the vicinity or environment of weeds.

The present invention provides an efficient prevention and treatment method for the control of herbicide resistant weeds, the said method being better than conventional methods.

1. A method of controlling herbicide resistant weeds by applying concurrently or subsequently or sequentially to a locus a combination of herbicide, the combination comprising.
(i) applying in a first application one or more herbicides selected from 5-enolpyruvylshikimate-3-phosphate synthase inhibiting herbicides, and glutamine synthetase inhibiting herbicides, and
(ii) applying in a second application one or more herbicides selected from 5-enolpyruvylshikimate-3-phosphate synthase inhibiting herbicides, glutamine synthetase inhibiting herbicides and acetyl-CoA carboxylase (ACCase) inhibiting herbicides,
wherein the second application is applied at least 7 days after the first application, and
wherein the herbicides of the first application and second application are applied at a rate of 0.1 to 10 L/ha.

2. The method as claimed in claim 1, wherein the 5-enolpyruvylshikimate-3-phosphate synthase inhibiting herbicide is glyphosate.

3. The method as claimed in claim 1, wherein the acetyl-CoA carboxylase inhibiting herbicide is selected from the group consisting of aryloxyphenoxy propionates, cyclohexanodiones, and phenylpyrazole.

4. The method as claimed in claim 3, wherein the aryloxyphenoxy propionate is selected from clodinafop, cyhalofop, haloxyfop fenoxaprop, fluazifop and quizalofop; the cyclohexanedione is selected from clethodim and sethoxydim; and the phenylpyrazole is pinoxaden.

5. The method as claimed in claim 1, wherein the glutamine synthetase inhibiting herbicide is glufosinate.

6. (canceled)

7. (canceled)

8. (canceled)

9. The method as claimed in claim 1, wherein the second application is applied at least 14 days after the first application.

10. The method as claimed in claim 1, wherein the second application is applied at least 35 days after the first application.

11. The method as claimed in claim 1, wherein the herbicide resistant weeds are selected from the group consisting of Echinochloa crus-galli, Setaria viridis, Setaria faberi, Setaria glauca, Setaria geniculata, Digitaria ciliaris, Digitaria sanguinalis, Digitaria horizontalis, Digitaria insularis, Eleusine indica, Poa annua, Alospecurus aequalis, Alopecurus myosuroides, Avena fatua, Sorghum halepense, Sorghum vuigare, Agropyron repens, Lolium multiflorum, Lolium perenne, Lolium rigidum, Bromus secalinus, Bromus tectorum, Hordeum jubatum, Aegilops cylindrica, Phalaris arundinacea, Phalaris minor, Apera spica-venti, Panicum dichotomiflorum, Panicum texanum, Panicum maximum, Brachiaria platyphylla, Brachiaria ruziziensis, Brachiaria plantaginea, Brachiaria decumbens, Brachiaria brizantha, Brachiaria humidicola, Cenchrus echinatus, Cenchrus pauciflorus, Eriochloa villosa, Pennisetum setosum, Chloris gayana, Eragrostis pilosa, Rhynchelitrum repens, Dactyloctenium aegyptium, Ischaemum rugosum, Oryza sativa, Paspalum notatum, Paspalum maritimum, Pennisetum clandestinum, Pennisetum setosum, and Rottboellia cochinchinensis.

12. The method as claimed in claim 11, wherein the herbicide resistant weed is Eleusine indica or Digitaria insularis.

13. The method as claimed in claim 6, wherein said herbicides are applied in an amount of about 5 g/ha to about 500 g/ha.

14. (canceled)

15. The method as claimed in claim 1, wherein the herbicides of the first application and second application are applied at a rate of 0.5 to 8 L/ha.

16. The method as claimed in claim 1, wherein the herbicides of the first application and second application are applied at a rate of 1 to 5 L/ha.

17. The method as claimed in claim 1, the method comprising:
(i) applying glyphosate and/or glufosinate to the locus as the first application; and
(ii) applying glyphosate and/or glufosinate to the locus as the second application.

18. The method as claimed in claim 1, the method comprising:
(i) applying glufosinate to the locus as the first application; and
(ii) applying glufosinate and/or an acetyl-CoA carboxylase inhibiting herbicides to the locus as the second application.

19. The method as claimed in claim 18, wherein the acetyl-CoA carboxylase inhibiting herbicides is selected from haloxyfop, clethodim, and mixtures thereof.
